(19) United States
(12) Patent Application Publication
(10) Pub. No.: US 2006/0289175 A1
(43) Pub. Date: Dec. 28, 2006

(54) Portable wireless system and method for detection and automatic suppression of fires

(76) Inventors: Gerald J. Gutowski, Glenview, IL (US); Stanley J. Benes, Round Lake Beach, IL (US); Lawrence A. Downing, Hoffman Estate, IL (US)

Correspondence Address: KOCH, WILLIAM;INGRASSIA FISHER & LORENZ, P.C., SUITE 325, 7150 E. CAMELBACK ROAD, SCOTTSDALE, AZ, 85251, US

(21) Appl. No.: 11/159,665

(22) Filed: Jun. 22, 2005

(51) Int. Cl. A62C 2/00; A62C 37/10

(52) U.S. Cl. 169/46; 169/60

(57) ABSTRACT

A portable, wireless, intelligent fire alarm and suppression system is provided for detecting and suppressing a fire in a plurality of locations. The system comprises a portable unit (10) including a sensor (18) for measuring data relating to a characteristic of a fire. A control logic (20) determines the type of fire in response to the data also determines an action for responding to the type of fire. A transmitter (22) wirelessly transmits at least one of the data and the action. A fire suppression element (14) includes one or more fire suppression materials, wherein at least one is actuated in response to the action. The control logic (20) determines a strategy for fighting the fire and may transmit instructions to other portable units to discharge their suppressants. Alternatively, a central control (24) includes a second transmitter/receiver (30) for receiving the at least one of the data and the action from the portable unit (10). A second control logic (26) coupled to the second transmitter/receiver (30) determines a strategy to suppress the fire in response to the at least one of the data and the action, and may transmit instructions to another portable unit (10) for activating a suppressant based on the strategy.

### FIELD OF THE INVENTION

The present invention generally relates to fire detection and suppression, and more particularly to a portable, wireless, intelligent fire alarm and suppression system for detecting and suppressing a fire in one or more locations.

### BACKGROUND OF THE INVENTION

Fires that cause injury, loss of life, and property occur daily. Fire detection/prevention systems to minimize or prevent such tragedies are well known. Though these systems may be voluntary, many times such a system is required by one or more governmental agency to meet a standard, such as that of the National Fire Protection Association's codes, standards, and regulations.

Known fire detection/prevention systems typically comprise a sensor that senses a toxic gas (e.g., smoke), flames, and temperature (e.g., excessive heat). Some known systems may also include a camera. This sensed information activates an alarm at the site of the sensor or in a general area, and may be transmitted to a central location that monitors the sensors. Some systems may also alert a fire and/or police department.

When a fire is sensed and an alarm given, people in the vicinity may evacuate. Some systems include a fire suppression means, e.g., a sprinkler system that sprays water in the general area of the fire, or a device that releases a gas that displaces oxygen from the fire.

While some fire alarm devices are portable, conventional alarm/suppression systems are integrated into a structure. For example, the well known overhead water sprinkler system includes an infrastructure of pipes for carrying the water throughout the structure.

Accordingly, it is desirable to provide a portable, wireless, intelligent fire alarm and suppression system for detecting and suppressing a fire in a plurality of locations. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A portable, wireless, intelligent fire alarm and suppression system is provided for detecting and suppressing a fire in a plurality of locations. The system comprises a portable unit including a sensor for measuring data relating to a characteristic of a fire. A control logic determines the type of fire in response to the data and also determines an action for responding to the type of fire. A transmitter wirelessly transmits at least one of the data and the action. A fire suppression element includes one or more types of fire suppression materials, wherein at least one is actuated in response to the action. In a first embodiment, a central control includes a second transmitter/receiver for receiving the at least one of the data and the action from the portable unit. A second control logic coupled to the second transmitter/receiver determines a strategy to suppress the fire in response to the at least one of the data and the action, and may transmit instructions to another portable unit for activating a suppressant based on the strategy. In a second embodiment, the portable unit communicates directly with the other portable units, determining a strategy to suppress the fire.

### BRIEF DESCRIPTION OF THE DRAWINGS

The present invention will hereinafter be described in conjunction with the following drawing figures, wherein like numerals denote like elements, and

FIG. 1 is a block diagram of a portable unit for fire detection and suppression in accordance with an exemplary embodiment of the present invention;

FIG. 2 is a block diagram of a system comprising a plurality of portable units and a central control for fire detection and suppression in accordance with an exemplary embodiment of the present invention;

FIG. 3 is a block diagram of a system comprising a plurality of portable units for fire detection and suppression in accordance with an exemplary embodiment of the present invention;

FIG. 4 is a block diagram of a central control in accordance with an exemplary embodiment of the present invention;

FIG. 5 is a flow chart of an exemplary method of operation of the portable unit of FIG. 1 for fire detection and suppression in accordance with an exemplary embodiment of the present invention;

FIG. 6 is a flow chart of an exemplary method of operation of the central control of FIG. 4 in accordance with an exemplary embodiment of the present invention; and

FIG. 7 is a flow chart of an exemplary method of operation of the portable unit of FIG. 1 for fire detection and suppression during normal operation in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The portable fire detection and suppression system described herein has wireless connectivity with a central authority for providing an alert to the central authority and receiving instructions therefrom, and for coordinating a fire suppression strategy with other sensor and suppression units. Alternatively, each unit may communicate directly with other units and determine a strategy for fighting the fire, without the need for a central authority.

The portable unit, in one embodiment, distinguishes between different types of fires and selects the best suppression agent for the type of fire detected. Each sensor and suppression unit is portable without any physical connections therebetween, e.g., no piping structure as used in known overhead sprinkler systems. As used herein, the terms “suppress”, “suppression”, and various other tenses thereof mean to extinguish, “put out”, impede progress, delay the advance, reduce intensity, etc. of the fire. Each sensor and suppression unit is portable and may be moved to different locations, whether for home, commercial, industrial, or military applications, and could be integrated with an existing suppression system, e.g., a water sprinkler system. As used herein, “portable” means a unit capable of being carried by one person from one location to another and that functions in either location.

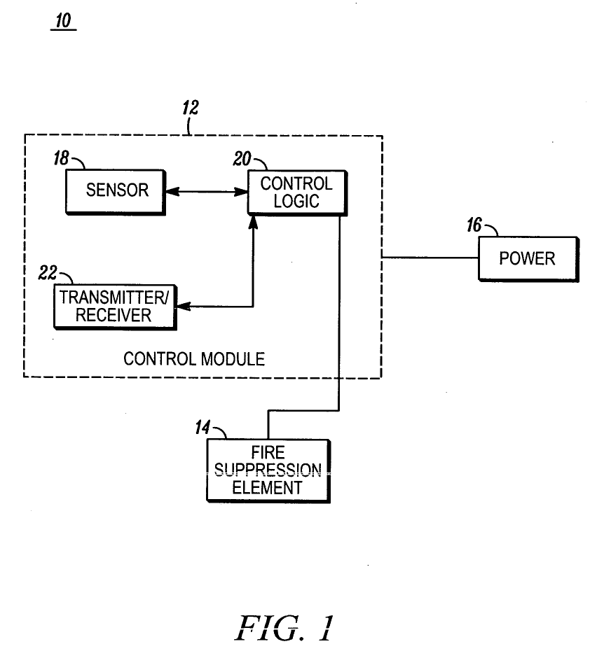

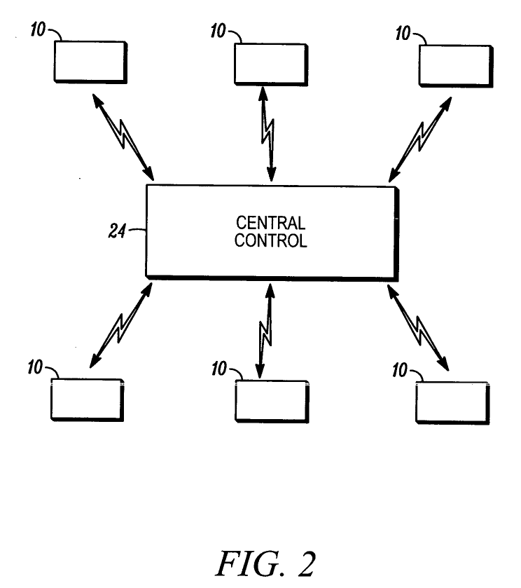

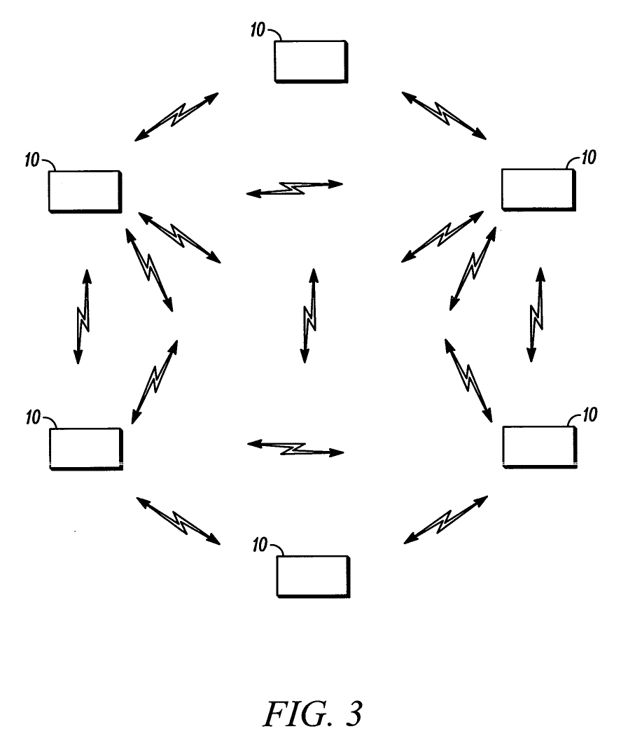

Referring to FIG. 1, an exemplary embodiment of a portable unit 10 for fire detection and suppression includes a control module 12, a fire suppression element 14, and a power element 16. The control module 12 comprises a sensor 18, control logic 20, and a wireless transmitter/receiver 22. The unit 10 is self-contained and may be positioned in a room or area of a facility, and may be moved to another room or area of the facility without any substantial changes to the structure of the facility (the portable unit 10 may be secured to the structure by screws or bolts, for example). The portable unit 10 may be one of a plurality of units 10 that communicate wirelessly with a central control 24 in a first embodiment (FIG. 2) or with other units 10 in a second embodiment (FIG. 3).

The sensor 18 comprises one or more sensing devices and may include any type of sensor device known in the industry that senses, for example, smoke, heat, flames, and odors. Typical smoke sensors include photoelectric sensors that are very sensitive and can detect smoldering fires such as cigarettes burning in beds or couches, and ionization sensors that can detect smoke from a paper or grease fire, for example. Typical heat sensors include thermal and IR sensors. Typical flame sensors include a UV sensor. Additionally, the sensor 18 may include a device with the ability to sense motion (e.g., people movement), the temperature (heat), and the percent of oxygen in the air for making an intelligent choice as to how to suppress the fire. This aspect will be subsequently discussed in more detail.

The transmitter/receiver 22 may comprise a known device for wirelessly sending data to the central control 24 (FIG. 2) or to other units (FIG. 3). The wireless protocol may comprise any of those known in the industry, including Bluetooth, 802.11x, cellular, Zigbee, Ultra-Wide Band (UWB), and others.

The control logic 20 includes a microprocessor for receiving data from the sensor 18, sending instructions to the fire suppression element 14 to activate or deactivate release of one or more suppression materials, and sending and receiving information to and from the transmitter 22. The control logic 20 provides intelligence, in response to date sensed by the sensor 18, by determining the type of fire and transmitting the location and state of the fire to central control 24 (FIG. 2) or to other units 10 (FIG. 3). The control logic 20 will determine the desired method, e.g., type of suppressant material, modify the suppression techniques based on sensed factors, e.g., human presence, and coordinate with other portable units 10 through the central control 24 or directly with other units 10 to follow a coordinated strategy to suppress the fire. For example, a fast moving fire may require neighboring portable units 10 to be activated before they individually determine the need to self activate. The control logic 20 also monitors the readiness status, e.g., power available and the pressure of the canister containing the suppressant material and transmits at least any abnormal readings to the central control.

The fire suppression element 14, upon instructions from the control logic 20, disperses a fire suppression material in the area in which it is positioned. There are many types of fire suppression material in use today that may be used in the element 14, including foam, dry chemicals, and gas. The preferred fire suppression material comprises non-sodium azide, which is an excellent suppression agent for electrical boxes, appliances, electrical equipment, and storage cabinets. The fire suppression element 14 may comprise a solid propellant gas generator wherein solid propellant tablets, upon ignition, discharge the gas generated directly into the ambient air. A typical solid propellant gas generator also includes an ignitor to initiate the combustion, a filter system to minimize the release of particulates from the combustion, a heat transfer mechanism to cool the gas before being discharged, and an exhaust mechanism to disperse the gas efficiently. A further description of a convention solid propellant gas generator may be found in “Gas Generator Induced Flow and its Effect on Fire Flame Extinction”, NIST-GCR-98-745, U.S. Department of Commerce, Feb. 1998. An additional advantage of the fire suppression element 14 in the portable unit 10 is that after the suppressant is discharged, the fire suppression element 14 may be recharged (suppressant replaced) at the location at which it was discharged, or taken to a recharging location and then returned.

The power element 16 preferably would comprise a battery, but may simply be a connector for accessing power available in the area in which the portable unit 10 is placed. Other power sources might include photovoltatic or thermocouple.

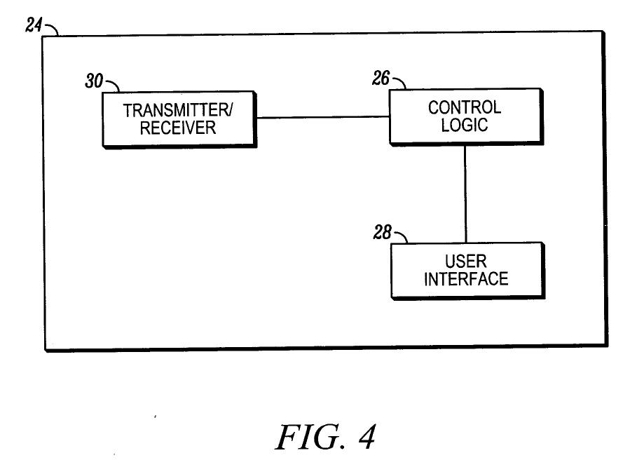

Referring to FIG. 4, the central control 24 comprises control logic 26, user interface 28, and a transmitter/receiver 30. The control logic 26 includes a microprocessor for sending and receiving data to and from the transmitter/receiver 30, and processes information from each of the portable units 10. The user interface 28, which for example may simply be a keyboard and monitor, allows the user to monitor the status of each of the portable units 10 and input instructions thereto.

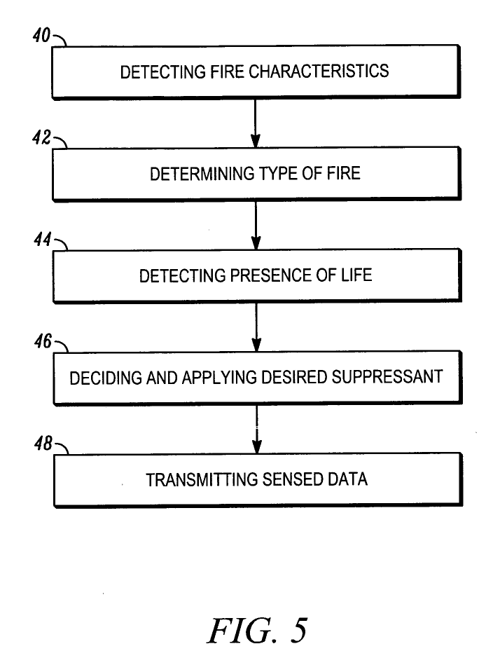

Referring to FIG. 5, one exemplary embodiment of the method of operation of the portable unit 10, when a fire or potential fire is present, comprises the sensor 18 detecting 40 one of the characteristics indicating the presence of a fire or the potential for a fire to exist. As previously mentioned, the portable unit 10 may comprise multiple sensors for detecting different characteristics of a fire. The type of fire is then determined 42. This determination, made by the control logic 20, may rely on more than one of the characteristics sensed. For example, a small amount of smoke detected by a photoelectric sensor, but not detected by an ionization sensor, combined with a sensed “normal room” temperature would indicate a smoldering fire. Optionally, a detection 44 of whether any living beings are present is made. If there is more than one suppressant material, a decision 46 is made on the suppressant material to be used, including whether to activate one or more of the material comprising the fire suppression element 14. If living beings are present, a benign suppressant material may be selected instead of a toxic suppressant material, for example. The central control 24 or the other units 10 are notified 48 of the data collected.

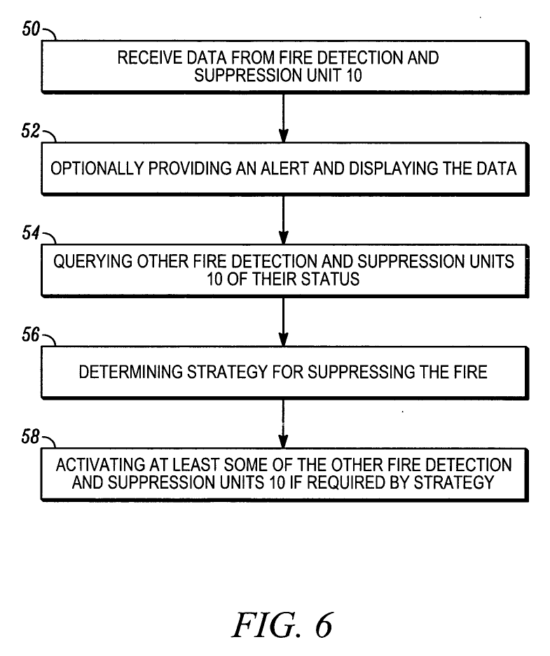

Referring to FIG. 6, in accordance with one exemplary embodiment of the method of operation of the central control 24, when a fire or potential fire is sensed by one of the portable units 10, the central control 24 receives 50 data from the portable unit 10. An alert is provided 52 and data is provided on a monitor, for example. A query is made 54 of other portable units 10 of their status and a strategy is determined 56 for suppressing the fire. This strategy may include activating 58 at least some of the other portable units 10 if required to effectively combat the fire.

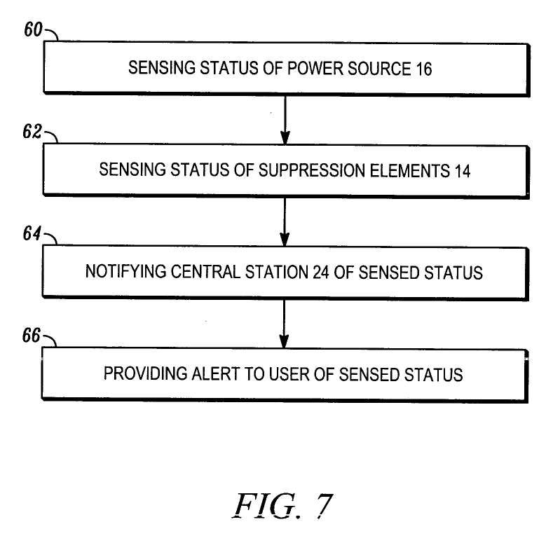

Referring to FIG. 7, one exemplary embodiment of the method of periodic operation of the portable units 10 and the central control 24 comprises sensing 60 the status of the power source 16, sensing 62 the status of the suppression element 14, notifying 64 the central control 24 of the sensed data, and alerting 66 users of the sensed status if an action would be required.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A fire detection and suppression system comprising:
a portable unit comprising:
a sensor for sensing at least one characteristic of a fire;
control logic coupled to the sensor for determining the type of fire in response to the at least one characteristic sensed and determining an action for responding to the type of fire;
a first transmitter/receiver for wirelessly transmitting at least one characteristic and the action; and
a fire suppression element coupled to the control logic and actuated based on the action.

2. The fire detection and suppression system of claim 1 wherein the fire suppression element comprises at least two fire suppression materials, wherein at least one is actuated based on the action.

3. The fire detection and suppression system of claim 2 wherein one of the fire suppression materials comprises non-sodium azide.

4. The fire detection and suppression system of claim 1 wherein the sensor measures at least two characteristics.

5. The fire detection and suppression system of claim 4 wherein the sensor determines the presence of life.

6. The fire detection and suppression system of claim 1 further comprising a central control for receiving the at least one characteristic and the action.

7. The fire detection and suppression system of claim 6 wherein the central control determines a strategy for fighting the fire.

8. The fire detection and suppression system of claim 1 further comprising additional portable units and wherein the first transmitter/receiver transmits the at least one characteristic and the action to the other portable units.

9. The fire detection and suppression system of claim 7 wherein the central control instructs at least one of the additional portable units to discharge a suppressant.

10. The fire detection and suppression system of claim 1 further comprising:
at least one more portable unit; and
a central control comprising:
a second transmitter/receiver for receiving the at least one characteristic and the action; and
a second control logic coupled to the second transmitter/receiver for determining a strategy to suppress the fire in response to the at least one characteristic and the action, and transmitting instructions to the at least one more portable units based on the strategy.

11. The fire detection and suppression system of claim 1 wherein the portable unit determines a strategy for fighting the fire.

12. The fire detection and suppression system of claim 11 further comprising additional portable units wherein the portable unit instructs at least one of the additional portable units to discharge a suppressant based on the strategy.

13. The fire detection and suppression system of claim 1 wherein the fire supression element is configured to be recharged with a suppressant to replenish a discharged suppressant.

14. In a portable fire detection and suppression system including control logic, a method comprising:
sensing the presence of characteristics indicating the likelihood of a fire, wherein the fire is one of two or more types;
determining, by the control logic, the type of fire from the characteristics; and
applying in a first location a fire suppression material based on the type of fire.

15. The method of claim 14 further comprising wirelessly transmitting the type of fire to a central control.

16. The method of claim 14 further comprising determining a strategy for suppressing the fire.

17. The method of claim 16 further comprising applying, in a second location, a fire suppression material based on the strategy.

18. The method of claim 14 further comprising determining the presence of life in the first location.

19. A fire detection and suppression system comprising:
two or more portable units, each comprising:
a sensor for sensing a characteristic of a fire;
a first control logic for determining a type of fire in response to the characteristic, and determining an action for responding to the type of fire;
a first transmitter/receiver for wirelessly transmitting at least one of the characteristic and the action; and
a fire suppression element actuated in response to the action; and
a central control comprising:
a second transmitter/receiver for receiving the at least one of the characteristic and the action from one of the two or more portable units; and
a second control logic coupled to the second transmitter/receiver for determining a strategy to suppress the fire in response to the at least one of the characteristic and the action, and optionally transmitting instructions to at least one of the other of the two or more portable units based on the strategy.

20. The fire detection and suppression system of claim 19 wherein the fire suppression element comprises at least two types of fire suppression materials, wherein at least one is actuated in response to the action.

21. The fire detection and suppression system of claim 20 wherein one of the fire suppression materials comprises non-sodium azide.

22. The fire detection and suppression system of claim 19 wherein the sensor measures at least two characteristics.

23. The fire detection and suppression system of claim 22 wherein the sensor determines the presence of life.
